(19) United States
(12) Patent Application Publication
(10) Pub. No.: US 2025/0356473 A1
(43) Pub. Date: Nov. 20, 2025

(54) BRIDGE IN-SERVICE GEOMETRIC FORM RECOGNITION METHOD BASED ON MULTI-POINT CLOUD FUSION

(71) Applicant: Southeast University, Jiangsu (CN)

(72) Inventors: Wen XIONG, Jiangsu (CN); Hongwei ZHANG, Jiangsu (CN); Yanjie ZHU, Jiangsu (CN)

(73) Assignee: Southeast University, Jiangsu (CN)

(21) Appl. No.: 18/871,470

(22) PCT Filed: Oct. 24, 2023
(86) PCT No.: PCT/CN2023/126220

§ 371 Date: Dec. 3, 2024

(30) Foreign Application Priority Data
Feb. 27, 2023 (CN) 202310167159.1

(51) Int. Cl. G06T 7/00; G06T 7/73; G06T 17/00

(52) U.S. Cl. CPC G06T 7/0002; G06T 7/73; G06T 17/00; G06T 2200/04; G06T 2207/10028; G06T 2207/30184; G06T 2210/56

(57) ABSTRACT

A bridge in-service geometric form recognition method based on multi-point cloud fusion comprises: defining a bridge in-service geometric form; obtaining multi-point cloud data of a bridge girder in different service periods under the condition of not stopping traffic; converting bridge three-dimensional point cloud data obtained by multiple times of scanning to a same coordinate system; fusing the point cloud data obtained by multiple times of scanning using a regional point cloud fitting algorithm to obtain a continuous and smooth theoretical girder point cloud reflecting a true spatial form of a bridge; and extracting three-dimensional coordinates of all points at any target transverse position in the theoretical girder point cloud in a span extension direction to obtain the bridge in-service geometric form.

### TECHNICAL FIELD

The invention belongs to the technical field of appearance inspection of bridge engineering in service, and particularly relates to a bridge in-service geometric form recognition method based on multi-point cloud fusion.

### DESCRIPTION OF RELATED ART

The bridge in-service geometric form, as an important evaluation indicator for appearance inspection of bridges in service, reflects mechanical responses to different load effects of the bridges in the current state, and if the geometric form of a bridge substantially deviates from the originally designed geometric form, the bridge has been possibly in a poor service condition. Therefore, the recognition of the geometric form of the bridge girder is one of key tasks of appearance inspection of bridges. Conventional detection means such as the total station, the level gauge and the GPS are low in efficiency, can only obtain a limited quantity of single-point information, and cannot obtain complete spatial information of bridges. Three-dimensional point cloud data are a set of a huge number of points and includes complete three-dimensional coordinate information of the surface of objects. However, during actual operation, the bridge girder is in a complex vibration state under the action of loads, and the vibration effect will be enhanced with the increase of the span of the bridge, leading to complex vibration noise in obtained point cloud data. How to accurately recognize a bridge in-service geometric form that can reflect the true operation state of a bridge from point cloud data with noise is a problem urgently to be solved.

### BRIEF SUMMARY OF THE INVENTION

The objective of the invention is to provide a bridge in-service geometric form recognition method based on multi-point cloud fusion to accurately recognize a bridge in-service geometric form that can reflect the true operation condition of a bridge from point cloud data with noise.

To fulfill the above objective, the invention provides the following technical solution: a bridge in-service geometric form recognition method based on multi-point cloud fusion comprises the following steps:
S1, defining a bridge in-service geometric form to be detected: a geometric form of a bridge girder constructed by three-dimensional coordinates of all points extracted at any target transverse position in a theoretical girder point cloud in a span extension direction;
S2, performing multiple times of three-dimensional laser scanning on a bridge structure in different service periods to obtain multi-point cloud data of the bridge girder in the different service periods under the condition of not stopping traffic, and converting the multi-point cloud data to a same target coordinate system;
S3, fusing the multi-point cloud data of the bridge girder obtained in S2 using a regional point cloud reconstruction algorithm to obtain a continuous and smooth theoretical girder point cloud reflecting a true spatial form of a bridge; and
S4, extracting three-dimensional coordinates of all points at any target transverse position in the theoretical girder point cloud obtained in S3 in the span extension direction to obtain the bridge in-service geometric form to be detected.

Further, S2 comprises the following sub-steps:
S201, in different service periods, continuously performing N times of three-dimensional laser scanning on a target bridge at a same detection station, and revising the bridge in-service geometric form to be detected according to temperature; and
S202, converting the multi-point cloud data to the same target coordinate system, wherein coordinate axes of two horizontal planes in the target coordinate system are parallel to a longitudinal direction or a transverse direction of the bridge.

Further, S3 comprises the following sub-steps:
S301, equally dividing each of N girder point clouds obtained by the N times of scanning into m=l_{z}/lₚ longitudinal regions in the longitudinal direction of the bridge, wherein l_{z} is a bridge span, and lₚ is a length of the longitudinal regions in the longitudinal direction of the bridge; performing regional multi-point cloud fusion on points in each longitudinal region using the regional point cloud reconstruction algorithm;
S302, for a J^{th} longitudinal region in point cloud data obtained by the N times of scanning, forming an algorithm input point set P_{J} by all points in the J^{th} longitudinal region, wherein l_{1J}, l_{2J} . . . l_{nJ}, J={1, 2 . . . m}, and a joint of cross-sections of every two adjacent longitudinal regions is a union set of all points in the cross-sections of the two adjacent longitudinal regions;
S303, performing regional multi-point cloud fusion on the points in each longitudinal region using the regional point cloud reconstruction algorithm, including calculation of three key parameters of the girder: a transverse position of the girder, a spatial form of a longitudinal central axis, and spatial torsion forms of end cross-sections, to obtain a theoretical girder point cloud of each region so as to form a bridge cross-sectional framework comprising multiple girder cross-sections; and
S304, according to the bridge cross-sectional framework obtained in S303, obtaining the continuous and smooth theoretical girder point cloud reflecting the true spatial form of the bridge using a grid point cloud generation method.

Further, S303 comprises the following sub-steps:
S303-1, establishing a vibration center theory: every time any one position or part B_{b} of the bridge is captured by a scanner to form a spatial coordinate point or point set P_{b} in the point cloud, the probability that P_{b} becomes closer to B_{b} is always greater than the probability that P_{b} becomes farther away from to B_{b}, that is, the bridge or a part of the bridge is always located at a vibration center of the corresponding point cloud;
S303-2, based on the vibration center theory, determining the transverse position of the girder in the longitudinal region using a stepwise capture algorithm: constructing a horizontal rectangular search box with a length lₚ and a width being a design width d of the girder, calculating an actual maximum transverse width dₘ of the point cloud, and extracting longitudinal and transverse coordinates of all the points in the point set P_{J} to form a planar two-dimensional point set

$${P}_{J}^{x y} ;$$

transversely moving the search box by a distance ζ, wherein during the moving process, the search box and the longitudinal region are kept identical in length in the longitudinal direction and kept parallel in direction; recording the number nₕ of points in the search box after the search box is moved by h steps, wherein ζ≤(dₘ−d)/10; when nₕ satisfies:

$${n}_{h} > {n}_{h - 1} , {n}_{h - 2} , {n}_{h + 1} , {n}_{h + 2} \qquad ( 1 )$$

determining a position of the search box having a maximum number of points located therein as the transverse position of the girder;
S303-3, based on the vibration center theory, calculating the spatial form of the longitudinal central axis of the theoretical girder point cloud of the longitudinal region:
because the longitudinal central axis of the girder in the longitudinal region is a longitudinal bisectrix of the girder and the transverse position of the girder has been determined in S303-2, extracting longitudinal and vertical coordinates of all points, located on the longitudinal bisectrix of the girder, in the point set P_{J} according to the design width d of the girder to form a two-dimensional point set

$${P}_{JC}^{x z} ;$$

forming a quasi-quadrangular area with a longitudinal length and a vertical height by the points in the point set

$${P}_{JC}^{x z} ,$$

wherein a maximum vertical height of the area is denoted as hₘₐₓ; according to the vibration center theory, determining a line with a slope k, moving the line in a vertical direction by a distance ηₖ, and if the number nₖ of points swept by the line is greater than the number n_{q} of points swept by lines l_{q} with other slopes when the lines l_{q} are moved in the same way, determining lₖ as the longitudinal central axis;
determining the spatial form of the longitudinal central axis lₖ using the stepwise capture method: creating a rectangular capture region R_{b} with a vertical height ω, an infinite longitudinal length and an initial slope k=0, wherein ω≤hₘₐₓ/10; moving R_{b} from bottom to top with a step size ε, wherein an initial position of R_{b} is denoted as Π₀, and a position of R_{b} after R_{b} is moved by i steps is denoted as Πᵢ; recording the number of points, located in R_{b}, in the point set

$${P}_{JC}^{x z}$$

after R_{b} is moved by i steps, wherein ε≤ω/5; when nᵢ satisfies:

$${n}_{i} > {n}_{i - 1} , {n}_{i - 2} , {n}_{i + 1} , {n}_{i + 2} \qquad ( 2 )$$

further determining a vertical dip angle of the longitudinal central axis based on the position of R_{b};
denoting a part, passing through the point set

$${P}_{JC}^{xz} ,$$

of R_{b} as R_{bp}; based on a center point of R_{bp}, clockwise or anticlockwise rotating R_{b} with a step size δₖ; recording the number n_{c} of points in R_{b} at the initial position, the number

$${n}_{j}^{s}$$

of points, located in R_{b}, in the point set

$${P}_{JC}^{x z}$$

after R_{b} is clockwise rotated j times and the number

$${n}_{j}^{n}$$

of points, located in R_{b}, in the point set

$${P}_{JC}^{x z}$$

after R_{b} is anticlockwise rotated times, wherein δₖ≤π/360; when,

$${n}_{c} < {n}_{1}^{s} , {n}_{2}^{s} and {n}_{c} > {n}_{1}^{n} , {n}_{2}^{n} \qquad ( 3 )$$

only clockwise rotating R_{b} subsequently; when,

$${n}_{j} > {n}_{j - 1} , {n}_{j - 2} , {n}_{j + 1} , {n}_{j + 2} \qquad ( 4 )$$

determining a vertical bisector of R_{bp} as the spatial form of the longitudinal central axis of the longitudinal region;
   when,

$${n}_{c} > {n}_{1}^{s} , {n}_{2}^{s} and {n}_{c} < {n}_{1}^{n} , {n}_{2}^{n} \qquad ( 5 )$$

only anticlockwise rotating R_{b} subsequentially; when,

$${n}_{j} > {n}_{j - 1} , {n}_{j - 2} , {n}_{j + 1} , {n}_{j + 2} \qquad ( 6 )$$

determining a vertical bisector of R_{bp} as the spatial form of the longitudinal central axis of the longitudinal region; and
S303-4, based on the vibration center theory, calculating the spatial torsion forms of end cross-sections of the theoretical girder point cloud of the longitudinal region: respectively extracting transverse and vertical coordinates of all points, located on cross-sections of two ends of the girder, in the point set P_{J} to form two-dimensional point sets

$${P}_{JS}^{xz}$$

and

$${P}_{JE}^{x z} ;$$

wherein, according to S302, the joint of the cross-sections of every two adjacent longitudinal regions shares a point set, so except an initial cross-section of the first longitudinal region and a terminal cross-section of the last longitudinal region, points of other cross-sections include points of two adjacent cross-sections, specifically, during point selection, a width of the terminal cross-section of the prior longitudinal region and a width of the initial cross-section of the next longitudinal region are both set to d_{J}/2, a union set of selected points is used as a two-dimensional point set of a cross-section of a joint of the two adjacent vertical sections, that is,

$${P}_{JS}^{x z} = {P}_{J - 1 , E}^{x z} , j ∈ \{ 2 … m \} \qquad ( 7 )$$

where,

$${P}_{JS}^{xz}$$

is a point set of the terminal cross-section of the J^{th} longitudinal region, and

$${P}_{J - 1 , E}^{xz}$$

is a point set of the initial cross-section of a (J+1)^{th} longitudinal region;
because the spatial form of the longitudinal central axis of the longitudinal region has been determined in S303-2, determining the torsion forms of the end cross-sections based on the point set

$${P}_{JS}^{yz}$$

using the stepwise capture algorithm: creating a cross-sectional segment which is as long as a design cross-section and is assigned with a thickness τ, and taking the cross-sectional segment as a capture region R_{d}, wherein τ≤hₘₐₓ/10, hₘₐₓ is a maximum vertical height within

$${P}_{JS}^{yz} ;$$

respectively placing two cross-sectional segments of the longitudinal region to end positions of the corresponding longitudinal central axis in a horizontal form, with a midpoint of each cross-sectional segment being located at a corresponding end point of the longitudinal central axis;
denoting a part, passing through the point set

$${P}_{JS}^{xz} ,$$

of R_{d} as R_{dp}; based on a center point of R_{bp}, clockwise or anticlockwise rotating R_{d} with a step size δ_{d}a; recording the number n_{c} of points located in R_{d} at an initial position, the number

$${n}_{j}^{s}$$

of points, located in R_{d}, in the point set

$${P}_{JS}^{xz}$$

after R_{d} is clockwise rotated j^{th} times, and the number

$${n}_{j}^{n}$$

of points, located in R_{d}, in the point set after R_{d} is anticlockwise rotated j^{th} times, wherein s represent clockwise, n represents anticlockwise, and δ_{d}≤π/360; when,

$${n}_{c} < {n}_{1}^{s} , {n}_{2}^{s} and {n}_{c} > {n}_{1}^{n} , {n}_{2}^{n} \qquad ( 8 )$$

only clockwise rotating R_{b} subsequentially; when,

$${n}_{j} > {n}_{j - 1} , {n}_{j - 2} , {n}_{j + 1} , {n}_{j + 2} \qquad ( 9 )$$

determining a torsion form of R_{d} at this moment as the spatial torsion form of the cross-section; when,

$${n}_{c} > {n}_{1}^{s} , {n}_{2}^{s} and {n}_{c} < {n}_{1}^{n} , {n}_{2}^{n} \qquad ( 10 )$$

only anticlockwise rotating R_{b} subsequentially; when,

$${n}_{j} > {n}_{j - 1} , {n}_{j - 2} , {n}_{j + 1} , {n}_{j + 2} \qquad ( 11 )$$

determining a torsion form of R_{d} at this moment is the spatial torsion form of the cross-section.

Further, a process of obtaining the theoretical girder point cloud meeting a target point cloud density requirement using the grid point cloud generation method in S304 comprises the following sub-steps:
S304-1, sequentially connecting all corresponding corner points of the girder cross-sections in the bridge cross-sectional framework by longitudinal connecting lines to form spatial areas of different parts of the girder in the longitudinal regions;
S304-2, setting a target point cloud density not less than q, dividing all segments and longitudinal connecting lines in the spatial areas by a length q, and sequentially connecting corresponding segmenting points on every two adjacent girder cross-sections and corresponding segmenting points on the longitudinal connecting line between every two girder cross-sections to form a point cloud grid finally; and
S304-3, generating at least one point coordinate at a stochastic position in each point cloud grid, and taking a set of all generated point coordinates as the continuous and smooth theoretical girder point cloud reflecting the true spatial form of the bridge.

Further, in S301, lₚ≤l_{z}/100.

Further, when N times of three-dimensional laser scanning are performed in S201, N is greater than or equal to 5; during scanning, a temperature difference between any two times of scanning is less than 3° C.; scanning times and temperature conditions corresponding to bridge point cloud data in different service periods are identical; and when the temperature difference between two times of scanning in different service periods is greater than a preset temperature difference threshold, the bridge in-service geometric form is revised according to actual temperature during the two times of scanning.

Further, in S303-3, when the longitudinal and vertical coordinates of all the points, located on the longitudinal bisectrix of the girder, in the point set P_{J} are extracted according to the design width d of the girder to form the two-dimensional point set

$${P}_{JC}^{xz} ,$$

bisectrix is set to have a transverse width: the width of the longitudinal bisectrix is be greater than d_{b}/50, wherein d_{b} is a design width of a base plate of the girder.

Further, in S303-4, when the transverse and vertical coordinates of all the points, on the cross-sections of the two ends of the girder, in the point set P_{J} are extracted respectively to form the two-dimensional point sets

$${P}_{JS}^{xz}$$

and

$${P}_{JE}^{xz} ,$$

a set cross-sectional thickness dⱼ is not greater than lₚ/100.

Compared with the prior art, the invention has the following beneficial effects: according to the bridge in-service geometric form recognition method based on multi-point cloud fusion, a clear definition of the bridge in-service geometric form is determined; accurate recognition of the bridge in-service geometric form is realized by means of bridge multi-point cloud data obtained by multiple times of three-dimensional laser scanning, coordinate system adjustment based on a coordinate transformation baseline and multi-point cloud fusion regression prediction based on a Gaussian process algorithm, so the problem that spatial information obtained by traditional measurement methods is insufficient is solved; and high-confidence recognition of the bridge in-service geometric form is realized to solve the problem of complex vibration noise in point cloud data caused by bridge vibrations, thus improving the control accuracy of the bridge service state.

### BRIEF DESCRIPTION OF THE SEVERAL VIEWS OF THE DRAWINGS

FIG. 1 is a flow diagram of a bridge in-service geometric form recognition method based on multi-point cloud fusion according to the invention;

FIG. 2 is an adjustment diagram of a point cloud coordinate system;

FIG. 3 is a division diagram of longitudinal regions of a girder point cloud;

FIG. 4 is a calculation diagram of the transverse position of a girder;

FIG. 5 is a calculation diagram of a spatial form of a longitudinal central axis of the girder;

FIG. 6 is a calculation diagram of spatial torsion forms of end cross-sections of the girder;

FIG. 7 is a schematic diagram of a generated point cloud grid.

### DETAILED DESCRIPTION OF THE INVENTION

To gain a better understanding of the technical contents of the invention, the invention is described below in conjunction with specific embodiments and accompanying drawings.

All aspects of the invention are described with reference to accompanying drawings, and many illustrative embodiments are shown in the accompanying drawings. The embodiments of the invention are not limited to those shown in the accompanying drawings. It should be understood that the invention can be implemented according to any one of multiple concepts and embodiments introduced above and concepts and implementations described in detail below because the concepts and embodiments disclosed by the invention are not limited to any implementation. In addition, some aspects disclosed by the invention can be used independently or be properly combined with other aspects disclosed by the invention to be used.

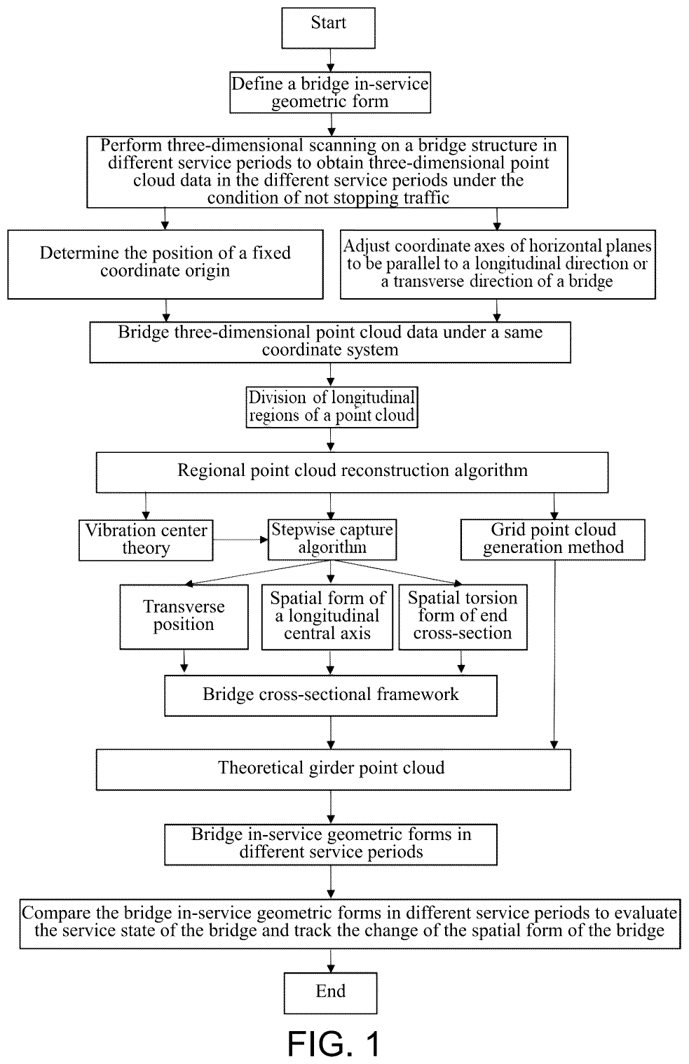

Referring to the flow diagram of the invention shown in FIG. 1, a bridge in-service geometric form recognition method based on multi-point cloud fusion comprises the following steps:
S1, a bridge in-service geometric form to be detected is defined: a geometric form of a bridge girder constructed by three-dimensional coordinates of all points extracted at any target transverse position in a theoretical girder point cloud in a span extension direction.

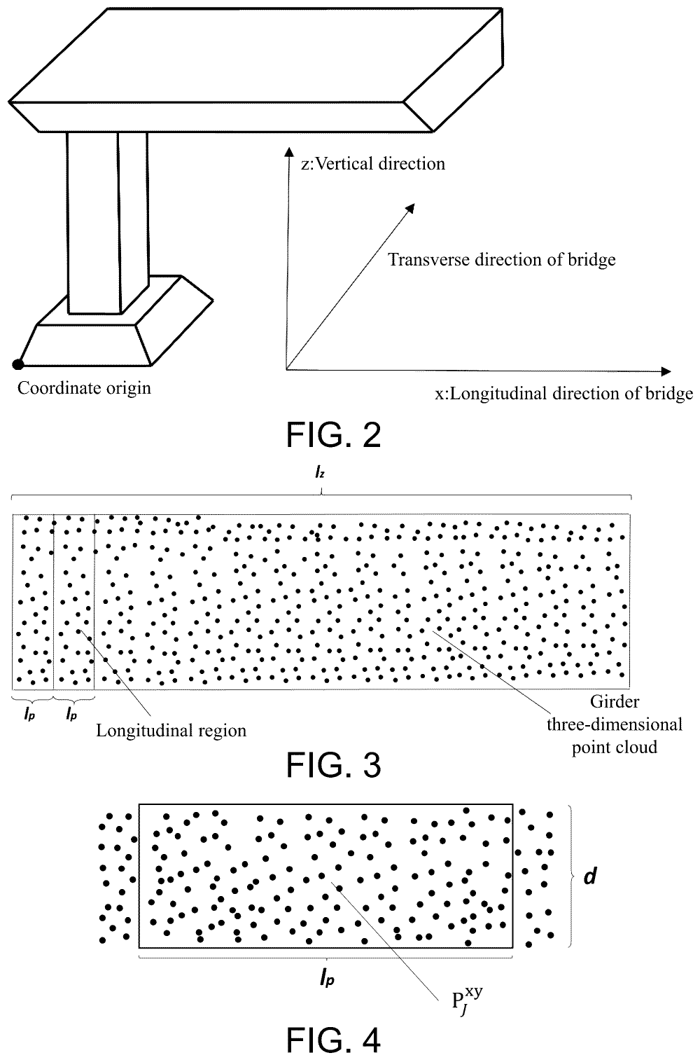

The bridge in-service geometric form is an equivalent and alternative geometric form that reflects girder vibration statistical characteristics, including vehicle/wind-induced vibration factors, of a bridge in any service period.
S2, multiple times of three-dimensional laser scanning are performed on a bridge structure in different service periods to obtain multi-point cloud data of the bridge girder in the different service periods under the condition of not stopping traffic; and referring to FIG. 2, a fixed coordinate origin is selected, the multi-point cloud data are converted to a same target coordinate system.
S3, the multi-point cloud data of the bridge girder obtained in S2 are fused using a regional point cloud reconstruction algorithm to obtain a continuous and smooth theoretical girder point cloud reflecting a true spatial form of a bridge.

The core contents of the regional point cloud reconstruction algorithm are a vibration center theory, a stepwise capture algorithm and a grid point cloud generation method, and the regional point cloud reconstruction algorithm focuses on the calculation of three key parameters of the girder: a transverse position of the girder, a spatial form of a longitudinal central axis, and spatial torsion forms of end cross-sections.

The vibration center theory discloses the position relationship between the bridge and corresponding point clouds; the stepwise capture algorithm calculates key spatial form parameters of the bridge girder based on the vibration center theory; and the grid point cloud generation method forms a theoretical girder point cloud satisfying a target point cloud density by means of the three key parameters of the girder: the transverse position of the girder, the spatial form of the longitudinal central axis, and the spatial torsion forms of the end cross-sections.
S4, three-dimensional coordinates of all points extracted at any target transverse position in the theoretical girder point cloud obtained in S3 are extracted in the span extension direction to obtain the bridge in-service geometric form to be detected. By comparing bridge in-service geometric forms in different periods, the structural state of the bridge in different service periods of the bridge can be evaluated, and the change of the spatial form of the bridge in different service periods of the bridge can be tracked.

In embodiments, the following basic conditions need to be met: point cloud data obtained should be as complete as possible in a longitudinal direction of the bridge to recognize a complete bridge in-service geometric form. For large-span bridges that cannot be completely scanned by a scanner, a reflecting target or other devices meeting the precision requirement should be arranged to obtain point cloud data of bridge sections that are not scanned by the scanner.

In embodiments, the bridge in-service geometric form based on multi-point cloud fusion in S1 is manifested as a set of three-dimensional spatial coordinate points.

In embodiments, S2 comprises the following sub-steps:
S201, in different service periods, N times of three-dimensional laser scanning are continuously performed on a target bridge at a same detection station, and the bridge in-service geometric form to be detected is revised according to temperature

Specifically, one or more detection stations at different positions are arranged, and the target bridge is scanned at the detection station to obtain complete point cloud data of the target bridge; and in different service periods, N times of three-dimensional laser scanning are continuously performed on the target bridge at the same detection station (N is greater than or equal to 5). During scanning, a temperature difference between any two times of scanning is less than 3° C.; scanning times and temperature conditions corresponding to bridge point cloud data in different service periods are identical; and when the temperature difference between two times of scanning in different service periods is greater than a preset temperature difference threshold, the bridge in-service geometric form is revised according to actual temperature during the two times of scanning.

S202, the multi-point cloud data are converted to the same target coordinate system, wherein coordinate axes of two horizontal planes in the target coordinate system are parallel to the longitudinal direction or the transverse direction of the bridge. Specifically, as shown in FIG. 2, for a planar linear girder, it is specified that, after conversion, the longitudinal direction of the bridge is an x-axis direction of a three-dimensional spatial coordinate system, the transverse direction of the bridge is a y-axis direction of the three-dimensional spatial coordinate system, and a vertical direction is a z-axis direction of the three-dimensional spatial coordinate system. For a planar curved bridge, a transverse direction of a pier, an abutment or a support is taken as the transverse direction of the bridge (the y-axis direction), a direction perpendicular to the transverse direction of the bridge is the longitudinal direction of the bridge (x-axis direction), and the vertical direction is the z-axis direction.
S3 comprises the following sub-steps:
S301, as shown in FIG. 3, each of N girder point clouds obtained by the N times of scanning is equally divided into m=l_{z}/lₚ longitudinal regions in the longitudinal direction of the bridge, wherein l_{z} is a bridge span, and lₚ is a length of the longitudinal regions in the longitudinal direction of the bridge; and to guarantee the fusion accuracy of the theoretical girder point cloud, lₚ≤l_{z}/100. Regional multi-point cloud fusion is performed on points in each longitudinal region using the regional point cloud reconstruction algorithm;
S302, for a J^{th} longitudinal region in point cloud data obtained by the N times of scanning, an algorithm input point set P_{J} is formed by all points in the J^{th} longitudinal region, wherein l_{1J}, l_{2J} . . . l_{nJ}, J={1, 2 . . . m}; and to guarantee the spatial continuity of the theoretical girder point cloud obtained by fusion, it is specified that a joint of cross-sections of every two adjacent longitudinal regions shares a point set, that is, a point set of a terminal cross-section of the prior longitudinal region is identical with a point set of an initial cross-section of the next longitudinal region, and the point set is a union set of all points in the cross-sections.
S303, regional multi-point cloud fusion is performed on the points in each longitudinal region using the regional point cloud reconstruction algorithm to obtain a theoretical girder point cloud of each region. The regional point cloud reconstruction algorithm includes calculation of three key parameters of the girder: the transverse position of the girder, the spatial form of the longitudinal central axis, and the spatial torsion forms of the end cross-sections. A bridge cross-sectional framework comprising multiple girder cross-sections is formed by means of the key parameters.
S304, according to the bridge cross-sectional framework obtained in S303, the continuous and smooth theoretical girder point cloud reflecting the true spatial form of the bridge is obtained using the grid point cloud generation method.

Wherein, S303 comprises the following sub-steps:
S303-1, the vibration center theory is established: every time any one position or part B_{b} (point, line, surface, cross-section or the like) of the bridge is captured by a scanner to form a spatial coordinate point or point set P_{b} in the point cloud, the probability that P_{b} becomes closer to B_{b} is always greater than the probability that P_{b} becomes farther away from to B_{b}, that is, the bridge or a part of the bridge is always located at a vibration center of the corresponding point cloud. Specifically, in the point cloud, the part B_{b} of the bridge is symmetrically moved in a main vibration direction by a small distance n based on the original position of the part B_{b}, and the number of points, swept by B_{b}, in the point set P_{b} is always greater than the number of points, swept by B_{b}, in the point set P_{b} under the same operation after the spatial position of B_{b} is changed. Based on this theory, the theoretical spatial position of the girder at this moment (or part of the girder) can be reversely deduced based on the distribution of the corresponding points in the point cloud with sufficient data.
S303-2, based on the vibration center theory, the transverse position of the girder in the longitudinal region is determined using a stepwise capture algorithm:

As shown in FIG. 4, a horizontal rectangular search box with a length lₚ and a width being a design width d of the girder is constructed, an actual maximum transverse width dₘ of the point cloud is calculated, and longitudinal and transverse coordinates of all the points in the point set Pⱼ are extracted to form a planar two-dimensional point set

$${P}_{J}^{xy} ;$$

the search box is transversely moved by a distance ζ, wherein during the moving process, the search box and the longitudinal region are kept identical in length in the longitudinal direction and kept parallel in direction; the number nₕ of points in the search box after the search box is moved by h steps is recorded, wherein ζ≤(dₘ−d)/10; when nₕ satisfies:

$${n}_{h} > {n}_{h - 1} , {n}_{h - 2} , {n}_{h + 1} , {n}_{h + 2} \qquad ( 1 )$$

a position of the search box having a maximum number of points located therein is determined as the transverse position of the girder;
S303-3, based on the vibration center theory, the spatial form of the longitudinal central axis of the theoretical girder point cloud of the longitudinal region is calculated:
because the longitudinal central axis of the girder in the longitudinal region is a longitudinal bisectrix of the girder and the transverse position of the girder has been determined in S303-2, longitudinal and vertical coordinates of all points, located on the longitudinal bisectrix of the girder, in the point set P_{J} are extracted according to the design width d of the girder to form a two-dimensional point set

$${P}_{JC}^{xz} .$$

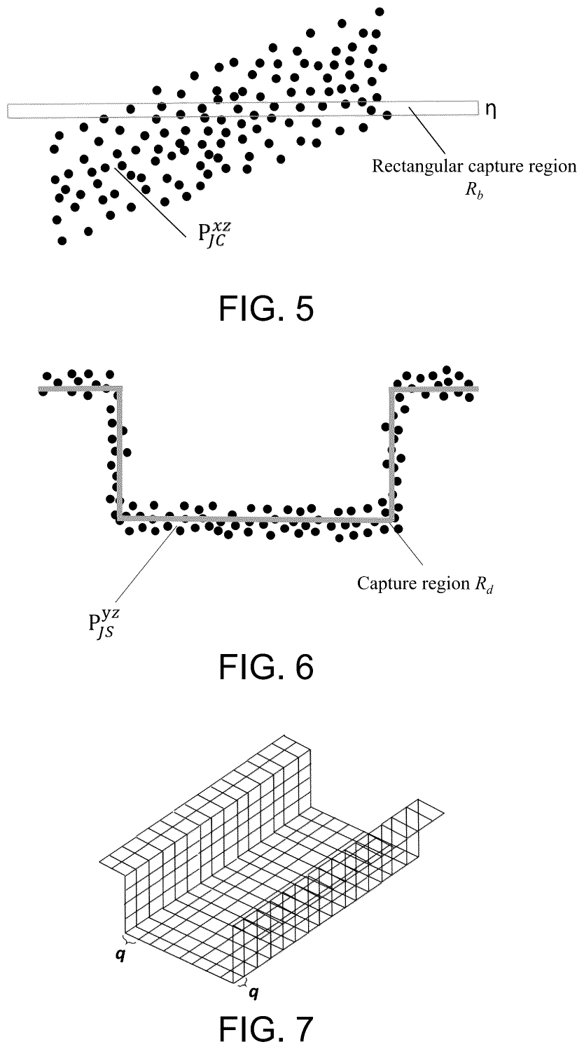

As shown in FIG. 5, a quasi-quadrangular area with a longitudinal length and a vertical height is formed by the points in the point set

$${P}_{JC}^{xz} ,$$

wherein a maximum vertical height of the area is denoted as hₘₐₓ; according to the vibration center theory, a line with a slope k is determined, the line is moved in the vertical direction by a distance ηₖ, and if the number nₖ of points swept by the line is greater than the number n_{q} of points swept by lines l_{q} with other slopes when the lines l_{q} are moved in the same way, lₖ is determined as the longitudinal central axis;
the spatial form of the longitudinal central axis lₖ is determined using the stepwise capture method: a rectangular capture region R_{b} with a vertical height w, an infinite longitudinal length and an initial slope k=0 is created, wherein ω≤hₘₐₓ/10; R_{b} is moved from bottom to top with a step size, wherein an initial position of R_{b} is denoted as Π₀, and a position of R_{b} after R_{b} is moved by i steps is denoted as Πᵢ; the number of points, located in R_{b}, in the point set

$${P}_{JC}^{xz}$$

after R_{b} is moved by i steps is recorded, wherein δ≤ω/5; when nᵢ satisfies:

$${n}_{i} > {n}_{i - 1} , {n}_{i - 2} , {n}_{i + 1} , {n}_{i + 2} \qquad ( 2 )$$

a vertical dip angle of the longitudinal central axis is further determined based on the position of R_{b};
a part, passing through the point set

$${P}_{JC}^{xz} ,$$

of R_{b} is denoted as R_{bp}; based on a center point of R_{bp}, R_{b} is rotated clockwise or anticlockwise with a step size δₖ; the number n_{c} of points in R_{b} at the initial position, the number

$${n}_{j}^{s}$$

of points, located in R_{b}, in the point set

$${P}_{JC}^{xz}$$

after R_{b} is clockwise rotated j times, and the number

$${n}_{j}^{n}$$

of points, located in R_{b}, in the point set

$${P}_{JC}^{xz}$$

after R_{b} is anticlockwise rotated j times are recorded, wherein δₖ≤π/360; when,

$${n}_{c} < {n}_{1}^{s} , {n}_{2}^{s} and {n}_{c} > {n}_{1}^{n} , {n}_{2}^{n} \qquad ( 3 )$$

R_{b} is only rotated clockwise subsequently; when,

$${n}_{j} > {n}_{j - 1} , {n}_{j - 2} , {n}_{j + 1} , {n}_{j + 2} \qquad ( 4 )$$

a vertical bisector of R_{bp} is determined as the spatial form of the longitudinal central axis of the longitudinal region;
when,

$${n}_{c} < {n}_{1}^{s} , {n}_{2}^{s} and {n}_{c} > {n}_{1}^{n} , {n}_{2}^{n} \qquad ( 5 )$$

R_{b} is only rotated anticlockwise subsequently; when,

$${n}_{j} > {n}_{j - 1} , {n}_{j - 2} , {n}_{j + 1} , {n}_{j + 2} \qquad ( 6 )$$

a vertical bisector of R_{bp} is determined as the spatial form of the longitudinal central axis of the longitudinal region.
S303-4, based on the vibration center theory, calculating the spatial torsion forms of end cross-sections of the theoretical girder point cloud of the longitudinal region: respectively extracting transverse and vertical coordinates of all points, located on cross-sections of two ends of the girder, in the point set P_{J} to form two-dimensional point sets

$${P}_{JS}^{xz}$$

and

$${P}_{JE}^{xz} .$$

To ensure a sufficient quantity of input data, the cross-section is set to have a certain thickness. To guarantee the calculation accuracy, it is specified that a set cross-sectional thickness d_{J} is not greater than lₚ/100.

According to S302, the joint of the cross-sections of every two adjacent longitudinal regions shares a point set, so except an initial cross-section of the first longitudinal region and a terminal cross-section of the last longitudinal region, points of other cross-sections include points of two adjacent cross-sections. Specifically, during point selection, a width of the terminal cross-section of the prior longitudinal region and a width of the initial cross-section of the next longitudinal region are both set to d_{J}/2, a union set of selected points is used as a two-dimensional point set of a cross-section of a joint of the two adjacent vertical sections, that is,

$${P}_{JS}^{xz} = {P}_{J - 1 , E}^{xz} , i ∈ \{ 2 … m \} \qquad ( 7 )$$

where,

$${P}_{JS}^{xz}$$

is a point set of me terminal cross-section of the J^{th} longitudinal region, and

$${P}_{J - 1 , E}^{xz}$$

is a point set of initial cross-section of a (J+1)^{th} longitudinal region;
as shown in FIG. 6, because the spatial form of the longitudinal central axis of the longitudinal region has been determined in S303-2, the torsion forms of the end cross-sections based on the point set

$${P}_{JS}^{xz}$$

are determined using the stepwise capture algorithm: a cross-sectional segment which is as long as a design cross-section and is assigned with a thickness τ is created and taken as a capture region R_{d}, wherein τ≤hₘₐₓ/10, hₘₐₓ is a maximum vertical height within

$${P}_{JS}^{xz} ;$$

two cross-sectional segments of the longitudinal region are respectively placed to end positions of the corresponding longitudinal central axis in a horizontal form, with a midpoint of each cross-sectional segment being located at a corresponding end point of the longitudinal central axis;
a part, passing through the point set

$${P}_{JS}^{xz} ,$$

of R_{d} is denoted as R_{dp}; based on a center point of R_{bp}, R_{d} is rotated clockwise or anticlockwise with a step size δ_{d}; the number n_{c} of points located in R_{d} at an initial position, the number

$${n}_{j}^{s}$$

of points, located in R_{d}, in the point set

$${P}_{JS}^{xz}$$

after R_{d} is clockwise rotated j^{th} times, and the number

$${n}_{j}^{n}$$

of points, located in R_{d}, in the point set

$${P}_{JS}^{xz}$$

after R_{d} is anticlockwise rotated j^{th} times are recorded, wherein s represents clockwise, n represents anticlockwise, and δ_{d}≤π/360; when,

$${n}_{c} < {n}_{1}^{s} , {n}_{2}^{s} and {n}_{c} > {n}_{1}^{n} , {n}_{2}^{n} \qquad ( 8 )$$

R_{b} is only rotated clockwise subsequentially; when,

$${n}_{j} > {n}_{j - 1} , {n}_{j - 2} , {n}_{j + 1} , {n}_{j + 2} \qquad ( 9 )$$

a torsion form of R_{d} at this moment is determined as the spatial torsion form of the cross-section; when,

$${n}_{c} > {n}_{1}^{s} , {n}_{2}^{s} and {n}_{c} < {n}_{1}^{n} , {n}_{2}^{n} \qquad ( 10 )$$

R_{b} is only rotated anticlockwise subsequentially; when,

$${n}_{j} > {n}_{j - 1} , {n}_{j - 2} , {n}_{j + 1} , {n}_{j + 2} \qquad ( 11 )$$

a torsion form of R_{d} at this moment is determined as the spatial torsion form of the cross-section;

As shown in FIG. 7, S304 comprises the following sub-steps:
S304-1, all corresponding corner points of the girder cross-sections in the bridge cross-sectional framework are sequentially connected by longitudinal connecting lines to form spatial areas of different parts of the girder in the longitudinal regions.
S304-2, the target point cloud density is set not to be less than q, all segments and longitudinal connecting lines in the spatial areas are divided by a length q, and corresponding segmenting points on every two adjacent girder cross-sections and corresponding segmenting points on the longitudinal connecting line between every two girder cross-sections are sequentially connected to form a point cloud grid finally.
S304-3, at least one point coordinate is generated at a stochastic position in each point cloud grid, and a set of all generated point coordinates is taken as the continuous and smooth theoretical girder point cloud reflecting the true spatial form of the bridge.

Although the invention has been expounded above with reference to preferred embodiments, the invention is not limited to the above preferred embodiments. Those ordinarily skilled in the art can make various modifications and embellishments with departing from the spirit and scope of the invention. Therefore, the protection scope of the invention should be defined by the claims.

1. A bridge in-service geometric form recognition method based on multi-point cloud fusion, comprising the following steps:
S1, defining a bridge in-service geometric form to be detected: a geometric form of a bridge girder constructed by three-dimensional coordinates of all points extracted at any of target transverse positions in a theoretical girder point cloud in a span extension direction;
S2, performing multiple times of three-dimensional laser scanning on a bridge structure in different service periods to obtain multi-point cloud data of the bridge girder in the different service periods under a condition of not stopping traffic, and converting the multi-point cloud data to a same target coordinate system;
S3, fusing the multi-point cloud data of the bridge girder obtained in the S2 using a regional point cloud reconstruction algorithm to obtain a continuous and smooth theoretical girder point cloud reflecting a true spatial form of a bridge; and
S4, extracting the three-dimensional coordinates of all points at any of the target transverse positions in the theoretical girder point cloud obtained in the S3 in the span extension direction to obtain the bridge in-service geometric form to be detected.

2. The bridge in-service geometric form recognition method based on multi-point cloud fusion according to claim 1, wherein the S2 comprises following sub-steps:
S201, in the different service periods, continuously performing N times of the three-dimensional laser scanning on a target bridge at a same detection station, and revising the bridge in-service geometric form to be detected according to temperature; and
S202, converting the multi-point cloud data to the same target coordinate system, wherein coordinate axes of two horizontal planes in the same target coordinate system are parallel to a longitudinal direction or a transverse direction of the bridge.

3. The bridge in-service geometric form recognition method based on multi-point cloud fusion according to claim 2, wherein the S3 comprises following sub-steps:
S301, equally dividing each of N girder point clouds obtained by the N times of the three-dimensional laser scanning into m=l_{z}/lₚ longitudinal regions in the longitudinal direction of the bridge, wherein l_{z} is a bridge span, and lₚ is a length of the longitudinal regions in the longitudinal direction of the bridge; performing regional multi-point cloud fusion on points in each of the longitudinal regions using the regional point cloud reconstruction algorithm;
S302, for a J^{th} longitudinal region in point cloud data obtained by the N times of the three-dimensional laser scanning, forming an algorithm input point set P_{J} by all points in the J^{th} longitudinal region, wherein l_{1J}, l_{2J} . . . l_{nJ}, J∈{1, 2 . . . m}, and a joint of cross-sections of every two adjacent longitudinal regions is a union set of all points in the cross-sections of the two adjacent longitudinal regions;
S303, performing regional multi-point cloud fusion on points in each of the longitudinal regions using the regional point cloud reconstruction algorithm, including calculation of three key parameters of the bridge girder: a transverse position of the bridge girder, a spatial form of a longitudinal central axis, and spatial torsion forms of end cross-sections, to obtain a theoretical girder point cloud of each of the longitudinal regions so as to form a bridge cross-sectional framework comprising multiple girder cross-sections; and
S304, according to the bridge cross-sectional framework obtained in the S303, obtaining the continuous and smooth theoretical girder point cloud reflecting the true spatial form of the bridge using a grid point cloud generation method.

4. The bridge in-service geometric form recognition method based on multi-point cloud fusion according to claim 3, wherein the S303 comprises following sub-steps:
S303-1, establishing a vibration center theory: every time any one position or part B_{b} of the bridge is captured by a scanner to form a spatial coordinate point or point set P_{b} in a point cloud, a probability that P_{b} becomes closer to B_{b} is always greater than a probability that P_{b} becomes farther away from to B_{b}, that is, the bridge or a part of the bridge is always located at a vibration center of the corresponding point cloud;
S303-2, based on the vibration center theory, determining the transverse position of the bridge girder in the longitudinal regions using a stepwise capture algorithm:
constructing a horizontal rectangular search box with a length lₚ and a width being a design width d of the bridge girder, calculating an actual maximum transverse width dₘ of the point cloud, and extracting longitudinal and transverse coordinates of all points in a point set P_{J} to form a planar two-dimensional point set
$${P}_{J}^{xy} ;$$
transversely moving the horizontal rectangular search box by a distance ζ, wherein during a moving process, the horizontal rectangular search box and the longitudinal regions are kept identical in length in the longitudinal direction and kept parallel in direction; recording a number nₕ of points in the horizontal rectangular search box after the horizontal rectangular search box is moved by h steps, wherein ζ≤(dₘ−d)/10; when nₕ satisfies:
$${n}_{h} > {n}_{h - 1} , {n}_{h - 2} , {n}_{h + 1} , {n}_{h + 2} \qquad ( 1 )$$
determining a position of the horizontal rectangular search box having a maximum number of the points located therein as the transverse position of the bridge girder;
S303-3, based on the vibration center theory, calculating the spatial form of the longitudinal central axis of the theoretical girder point cloud of the longitudinal regions:
because the longitudinal central axis of the bridge girder in the longitudinal region is a longitudinal bisectrix of the bridge girder and the transverse position of the bridge girder has been determined in the S303-2, extracting longitudinal and vertical coordinates of all points, located on the longitudinal bisectrix of the bridge girder, in the point set P_{J} according to the design width d of the girder to form a two-dimensional point set
$${P}_{JC}^{xz} ;$$
forming a quasi-quadrangular area with a longitudinal length and a vertical height by points in the two-dimensional point set
$${P}_{JC}^{xz} ,$$
wherein a maximum vertical height of the quasi-quadrangular area is denoted as hₘₐₓ; according to the vibration center theory, determining a line with a slope k, moving the line in a vertical direction by a distance ηₖ, and if a number nₖ of points swept by the line is greater than a number n_{q} of points swept by lines l_{q} with other slopes when the lines l_{q} are moved in a same way, determining lₖ as the longitudinal central axis;
determining the spatial form of the longitudinal central axis lₖ using a stepwise capture method: creating a rectangular capture region R_{b} with a vertical height w, an infinite longitudinal length and an initial slope k=0, wherein ω≤hₘₐₓ/10; moving R_{b} from bottom to top with a step size ε, wherein an initial position of R_{b} is denoted as Π₀, and a position of R_{b} after R_{b} is moved by i steps is denoted as Πᵢ; recording a number of points, located in R_{b}, in the two-dimensional point set
$${P}_{JC}^{xz}$$
after R_{b} is moved by the i steps, wherein ε≤ω/5; when nᵢ satisfies:
$${n}_{i} > {n}_{i - 1} , {n}_{i - 2} , {n}_{i + 1} , {n}_{i + 2} \qquad ( 2 )$$
further determining a vertical dip angle of the longitudinal central axis based on a position of R_{b};
denoting a part, passing through the two-dimensional point set
$${P}_{JC}^{xz} ,$$
of R_{b} as R_{bp}; based on a center point of R_{bp}, clockwise or anticlockwise rotating R_{b} with a step size δₖ; recording a number n_{c} of points in R_{b} at the initial position, a number
$${n}_{j}^{s}$$
of points, located in R_{b}, in the two-dimensional points set
$${P}_{JC}^{xz}$$
after R_{b} is clockwise rotated j times, and a number
$${n}_{j}^{n}$$
of points, located in R_{b}, in the two-dimensional point set
$${P}_{JC}^{xz}$$
after R_{b} is anticlockwise rotated j times, wherein δₖ≤π/360; when,
$${n}_{c} < {n}_{1}^{s} , {n}_{2}^{s} and {n}_{c} > {n}_{1}^{n} , {n}_{2}^{n} \qquad ( 3 )$$
only clockwise rotating R_{b} subsequently; when,
$${n}_{j} > {n}_{j - 1} , {n}_{j - 2} , {n}_{j + 1} , {n}_{j + 2} \qquad ( 4 )$$
determining a vertical bisector of R_{bp} as the spatial form of the longitudinal central axis of the longitudinal region;
when,
$${n}_{c} > {n}_{1}^{s} , {n}_{2}^{s} and {n}_{c} < {n}_{1}^{n} , {n}_{2}^{n} \qquad ( 5 )$$
only anticlockwise rotating R_{b} subsequentially; when,
$${n}_{j} > {n}_{j - 1} , {n}_{j - 2} , {n}_{j + 1} , {n}_{j + 2} \qquad ( 6 )$$
determining the vertical bisector of R_{bp} as the spatial form of the longitudinal central axis of the longitudinal regions; and
S303-4, based on the vibration center theory, calculating the spatial torsion forms of end cross-sections of the theoretical girder point cloud of the longitudinal regions: respectively extracting transverse and vertical coordinates of all points, located on cross-sections of two ends of the girder, in the point set P_{J} to form two-dimensional point sets
$${P}_{JS}^{xz}$$
and
$${P}_{JE}^{xz} ;$$
wherein, according to the S302, the joint of the cross-sections of the every two adjacent longitudinal regions shares a point set, so except an initial cross-section of a first longitudinal region and a terminal cross-section of a last longitudinal region, points of other cross-sections include points of the two adjacent cross-sections, specifically, during point selection, a width of the terminal cross-section of a prior longitudinal region and a width of the initial cross-section of a next longitudinal region are both set to d_{J}/2, a union set of selected points is used as a two-dimensional point set of a cross-section of a joint of the two adjacent vertical sections, that is,
$${P}_{JS}^{xz} = {P}_{J - 1 , E}^{xz} , j ∈ \{ 2 … m \} \qquad ( 7 )$$
where
$${P}_{JS}^{xz}$$
is a point set of the terminal cross-section of the J^{th} longitudinal region, where, and
$${P}_{J - 1 , E}^{xz}$$
is a point set of the initial cross-section of a (J+1)^{th} longitudinal region;
because the spatial form of the longitudinal central axis of the longitudinal region has been determined in the S303-2, determining the torsion forms of the end cross-sections based on the point set
$${P}_{JS}^{xz}$$
using the stepwise capture algorithm: creating a cross-sectional segment which is as long as a design cross-section and is assigned with a thickness τ, and taking the cross-sectional segment as a capture region R_{d}, wherein τ≤hₘₐₓ/10, hₘₐₓ is a maximum vertical height within
$${P}_{JS}^{xz} ;$$
respectively placing two cross-sectional segments of the longitudinal region to end positions of the corresponding longitudinal central axis in a horizontal form, with a midpoint of each cross-sectional segment being located at a corresponding end point of the longitudinal central axis;
denoting a part, passing through the point set
$${P}_{JS}^{xz} ,$$
of R_{d} as R_{dp}; based on a center point of R_{bp}, clockwise or anticlockwise rotating R_{d} with a step size δ_{d}; recording a number n_{c} of points located in R_{d} at an initial position, a number
$${n}_{j}^{s}$$
of points, located in R_{d}, in the point set
$${P}_{JS}^{xz}$$
after R_{d} is clockwise rotated j^{th} times, and a number
$${n}_{j}^{n}$$
of points, located in R_{d}, in the point set
$${P}_{JS}^{xz}$$
after R_{d} is anticlockwise rotated j^{th} times, wherein s represent clockwise, n represents anticlockwise, and δ_{d}≤π/360; when,
$${n}_{c} < {n}_{1}^{s} , {n}_{2}^{s} and {n}_{c} > {n}_{1}^{n} , {n}_{2}^{n} \qquad ( 8 )$$
only clockwise rotating R_{b} subsequentially; when,
$${n}_{j} > {n}_{j - 1} , {n}_{j - 2} , {n}_{j + 1} , {n}_{j + 2} \qquad ( 9 )$$
determining a torsion form of R_{d} at this moment as the spatial torsion form of the cross-section;
when,
$${n}_{c} > {n}_{1}^{s} , {n}_{2}^{s} and {n}_{c} < {n}_{1}^{n} , {n}_{2}^{n} \qquad ( 10 )$$
only anticlockwise rotating R_{b} subsequentially; when,
$${n}_{j} > {n}_{j - 1} , {n}_{j - 2} , {n}_{j + 1} , {n}_{j + 2} \qquad ( 11 )$$
determining a torsion form of R_{d} at this moment as the spatial torsion form of the cross-section.

5. The bridge in-service geometric form recognition method based on multi-point cloud fusion according to claim 4, wherein a process of obtaining the theoretical girder point cloud meeting a target point cloud density requirement using the grid point cloud generation method in the S304 comprises following sub-steps:
S304-1, sequentially connecting all corresponding corner points of the girder cross-sections in the bridge cross-sectional framework by longitudinal connecting lines to form spatial areas of different parts of the girder in the longitudinal regions;
S304-2, setting a target point cloud density not less than a length q, dividing all segments and longitudinal connecting lines in the spatial areas by the length q, and sequentially connecting corresponding segmenting points on every two adjacent girder cross-sections and corresponding segmenting points on the longitudinal connecting line between every two girder cross-sections to form a point cloud grid finally; and
S304-3, generating at least one point coordinate at a stochastic position in each point cloud grid, and taking a set of all generated point coordinates as the continuous and smooth theoretical girder point cloud reflecting the true spatial form of the bridge.

6. The bridge in-service geometric form recognition method based on multi-point cloud fusion according to claim 3, wherein in the S301, lₚ≤l_{z}/100.

7. The bridge in-service geometric form recognition method based on multi-point cloud fusion according to claim 1, wherein when the N times of three-dimensional laser scanning are performed in the S201, N is greater than or equal to 5; during scanning, a temperature difference between any two times of scanning is less than 3° C.; scanning times and temperature conditions corresponding to bridge point cloud data in different service periods are identical; and when the temperature difference between two times of scanning in different service periods is greater than a preset temperature difference threshold, the bridge in-service geometric form is revised according to actual temperature during the two times of scanning.

8. The bridge in-service geometric form recognition method based on multi-point cloud fusion according to claim 4, wherein,
in the S303-3, when the longitudinal and vertical coordinates of all points, located on the longitudinal bisectrix of the girder, in the point set P_{J} are extracted according to the design width d of the girder to form the two-dimensional point set
$${P}_{JC}^{xz} ,$$
the longitudinal bisectrix is set to have a transverse width: the width of the longitudinal bisectrix is be greater than d_{b}/50, wherein d_{b} is a design width of a base plate of the girder.

9. The bridge in-service geometric form recognition method based on multi-point cloud fusion according to claim 4, wherein in the S303-4, when the transverse and vertical coordinates of all points, on the cross-sections of the two ends of the girder, in the point set P_{J} are extracted respectively to form the two-dimensional point sets
$${P}_{JS}^{xz}$$
and
$${P}_{JE}^{xz} ,$$
a set cross-sectional thickness dⱼ is not greater than lₚ/100.
